(19) United States
(12) Patent Application Publication
(10) Pub. No.: US 2015/0348309 A1
(43) Pub. Date: Dec. 3, 2015

(54) CROSS SECTION CREATION AND MODIFICATION

(71) Applicant: Schlumberger Technology Corporation, Sugar Land, TX (US)

(72) Inventors: Yu Lin, Katy, TX (US); Tze Ma, Abingdon (GB); Theresa Hartman, Houston, TX (US)

(73) Assignee: Schlumberger Technology Corporation, Sugar Land, TX (US)

(21) Appl. No.: 14/294,605

(22) Filed: Jun. 3, 2014

(51) Int. Cl. G06T 15/08; G06T 17/00

(52) U.S. Cl. CPC G06T 15/08; G06T 17/00

(57) ABSTRACT

A method for analyzing a three-dimensional (3D) data volume that stores field data includes detecting a natural feature of the :field data to be within a pre-determined range of a position selected by an analyst user. In response, a line segment is generated within the 3D data volume based on a location of the natural feature. A hinge of a hinged two-dimensional (2D) facet in a sequence of hinged 2D facets is selected within the 3D data volume. In particular, the sequence of hinged 2D facets corresponds to a portion of the field data that is displayed on the sequence of hinged 2D facets. Based on the line segment and the hinge, a new 2D facet is generated within the 3D data volume. Accordingly, an additional portion of the field data corresponding to the new 2D facet is displayed on the new 2D facet to the analyst user.

### BACKGROUND

Exploration and production (E&P) of hydrocarbons in a field, such as an oil field, may be analyzed and modeled based on data volumes that include information describing properties of a subterranean region in the field. For example, a data volume may be used in interpretation applications to make decisions to locate oil and gas. Information included in the data volume may he viewed on a two-dimensional (2D) canvas within a three-dimensional (3D) space (referred to as a 3D data volume) corresponding to the subterranean region. The 2D canvas includes multiple vertical facets in an area of interest, and is referred to as a cross section of the 3D data volume. On this 2D canvas, i.e., cross section, an analyst user can display a variety of subjects, including borehole paths, well logs, seismic cubes, as yell as simulation results. Simultaneous visualization of data from multiple domains on a common cross section allows the analyst user to understand correlations among data from these domains.

In the top view (also referred to as the map view) of the 3D data volume, a cross section may be represented by a zigzag path defined by a series of geographical locations referred to as hinges of the cross section. Traditionally, the cross section is constructed in the map view or top view of the area of interest by an individual manually selecting a sequence of well heads.

### SUMMARY

In general, in one aspect, embodiments relate to a method for analyzing a three-dimensional (3D) data volume. The method includes receiving, from an analyst user, a selected position within the 3D data volume, wherein the 3D data volume comprises field data, detecting, by a processor of a computer system, a pre-determined natural feature of the field data to be within a pre-determined range of the selected position, generating, by the processor and in response to the detecting, a line segment within the 3D data volume based on a location of the pre-determined natural feature, and selecting a first hinge of a first hinged two-dimensional (2D) facet in a sequence of hinged 2D facets within the 3D data volume. The sequence of hinged 2D facets corresponds to a portion of the field data that is displayed on the sequence of hinged 2D facets. The method further includes generating, by the processor and based at least on the line segment and the first hinge, a first new 2D facet within the 3D data volume, and displaying, to the analyst user, an additional portion of the field data corresponding to the first new 2D facet. The additional portion of the field data is displayed on the first new 2D facet.

Other aspects will be apparent from the following description and the appended claims.

### BRIEF DESCRIPTION OF DRAWINGS

The appended drawings illustrate several embodiments of cross section creation and modification and are not to be considered limiting of its scope, for cross section creation and modification may admit to other equally effective embodiments.

FIG. 1.1 is a schematic view, partially in cross-section, of a field in Which one or more embodiments of cross section creation and modification may be implemented.

FIG. 1.2 shows a schematic diagram of a system in accordance with one or more embodiments.

FIG. 2 shows a flowchart in accordance with one or more embodiments.

FIGS. 3.1, 3.2, and 3.3, and 3.4 show an example in accordance with one or more embodiments.

FIG. 4 shows a computing system in accordance with one or more embodiments.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding. However, it will be apparent to one of ordinary skill in the art that one or more embodiments may be practiced without these specific details. In other instances, well-known features have not been described in detail to avoid unnecessarily complicating the description.

A three-dimensional (3D) data volume is a computer modeled 3D space corresponding to a subterranean region. In particular, information describing properties of the subterranean region is stored at multiple grid points in the computer modeled 3D space. Each grid point represents a particular location in the subterranean region. Grid points are next to each other when the grid point's corresponding locations are next to each other. A facet is a polygon surface (i.e., two-dimensional (2D) on a 3D geometric shape. In other words, a facet is a polygon surface on or within the 3D data volume. A cross section is a connected sequence of facets internal to the 3D data volume. Adjacent facets in the sequence are connected along a common edge of the adjacent facets. The common edge is referred to as a hinge. Accordingly, the facets of a cross section are also referred to as hinged facets.

Examples of subterranean information stored in the 3D data volume may include physical and chemical properties of the geological formation in the subterranean region. Further, the subterranean information may include different types (referred to as domains) of information, such as geological model, petroleum data, well trajectories, etc. For example, well logs sampled along the well trajectories provide relatively precise and direct information of physical and chemical properties. A user using the 3D data volume to analyze the properties of the subterranean region is referred to as an analyst user. For example, an analyst user may be a geoscientist, a petroleum engineer, a student, or any other individual or group of individuals that analyze the properties of the subterranean region. In defining a cross section of the 3D, data volume, the analyst user may examine the areas between adjacent wells to determine whether a specific well or a portion thereof should be selected as a hinge of the cross section.

In general, embodiments provide a method and system for interactive modification or creation of the cross section. One or more embodiments facilitate an analyst user to modify the cross section by moving a point on the cross section to a selected position. For example, the selected position may be adjacent to a feature of the 3D data volume. A new hinge is created at the location of the feature. For example, the point on the cross section that is moved may be a hinge of the original cross section. By moving the point to the selected position, two facets of the original cross section connecting to the hinge are replaced by two new facets connecting to the new hinge to create a new cross section. In another example, the point on the original cross section may he between two hinges of the original cross section. By moving the point to the selected position, the facet of the original cross section between the two hinges is replaced by two new facets connecting the new hinge and the two hinges to create a new cross section. One or more embodiments facilitate the analyst user to create the cross section by creating a new hinge at individual selected positions adjacent to individual features of the 3D data volume.

In one or more embodiments, the moving action is performed by dragging and dropping on a graphical user interface displaying at least a portion of the 3D data volume. During the dragging and dropping action, data in the 3D data volume at the location of the cross section is dynamically displayed on the cross section. As the modified portion or newly created portion of the cross section moves across the 3D data volume in a sweeping motion, the dynamic display of data forms an animation sequence of data on the cross section during the dragging and dropping action. In other words, during the dragging portion of the dragging and dropping action, the graphical user interface is dynamically and regularly updated to display resulting cross sections by a new hinge at each location of the dragging action. By viewing the animation sequence as the point on the cross section is being dragged, the analyst user may determine a proper position of the new hinge as being when the displayed data on the cross section is considered acceptable by the analyst user in other words, the animation sequence of data on the cross section allows immediate feedback to the analyst user in selecting the new hinge.

Further, simultaneous visualization of data from multiple domains on a common cross section allows the analyst user to understand correlations among data form these domains. Accordingly, a state-of-art geological earth model may be constructed for geological and geophysical interpretations, petroleum and reservoir simulations, production predictions, as well as drilling and pipeline planning, etc

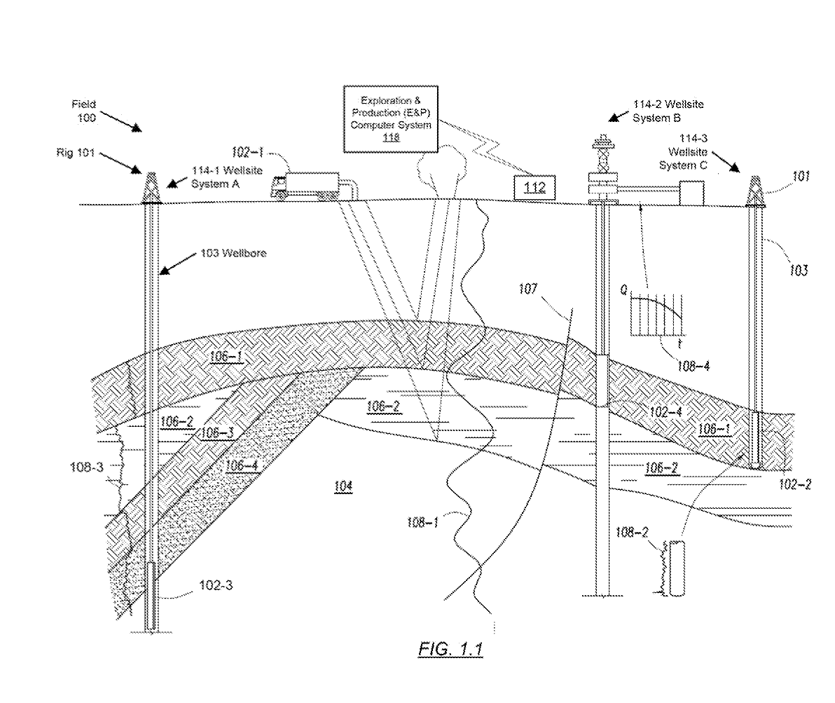

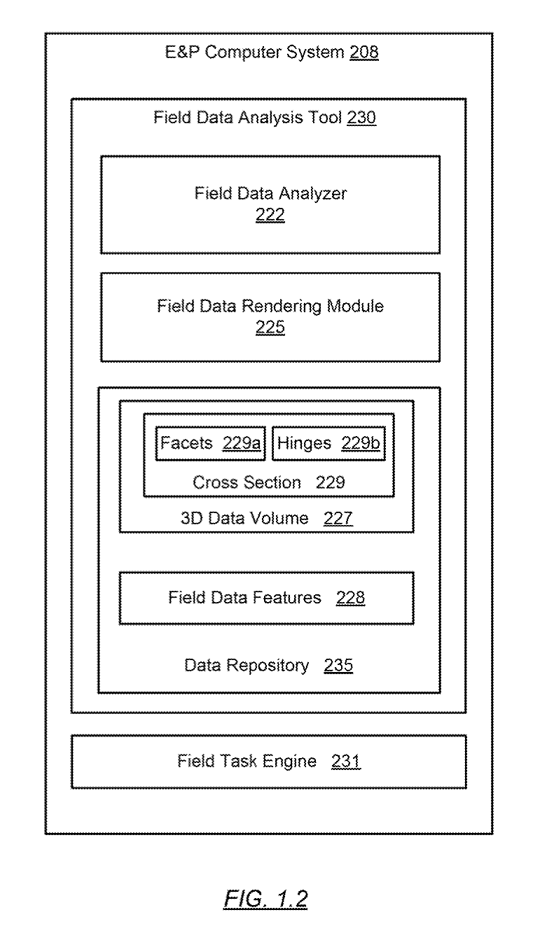

FIG. 1.1 depicts a schematic view, partially in cross section, of a field (100) in which one or more embodiments of cross section creation and modification may be implemented. In one or more embodiments, one or more of the modules and elements shown in FIG. 1.1 may he omitted, repeated, and/or substituted. Accordingly, embodiments of cross section creation and modification should not be considered limited to the specific arrangements of modules shown in FIG. 1.1.

As shown in FIG. 1.1, the field (100) includes the subterranean formation (104), data acquisition tools (102-1), (102-2), (102-3), and (102-4), wellsite system A (1 14-1), wellsite system B (114-2), wellsite system C (114-3), a surface unit (112), and an exploration and production (E&P) computer system (118). The subterranean formation (104) includes several geological structures, such as a sandstone layer (106-1), a limestone layer (106-2), a shale layer (106-3), a sand layer (106-4), and a fault line (107).

In one or more embodiments, data acquisition tools (102-1), (102-2), (102-3), and (102-4) are positioned at various locations along the field (100) for collecting data of the subterranean formation (104), referred to as survey operations. In particular, these data acquisition tools are adapted to measure the subterranean formation (104) and detect the characteristics of the geological structures of the subterranean formation (104). For example, data plots (108-1), (108-2), (108-3), and (108-4) are depicted along the field (100) to demonstrate the data generated by these data acquisition tools. Specifically, the static data plot (108-1) is a seismic two-way response time. Static plot (108-2) is core sample data measured from a core sample of the formation (104). Static data plot (108-3) is a logging trace, referred to as a well log. Production decline curve or graph (108-4) is a dynamic data plot of the fluid flow rate over time. Other data may also be collected, such as historical data, analyst user inputs, economic information, and/or other measurement data and other parameters of interest.

Further as shown in FIG. 1.1, each of the wellsite system A (114-1), wellsite system 13 (114-2), and wellsite system C (114-3) is associated with a rig, a wellbore, and other wellsite equipment configured to perform wellbore operations, such as logging, drilling, fracturing, production, or other applicable operations. For example, the wellsite system A (114-1) is associated with a rig (101), a wellbore (103), and drilling equipment to perform drilling operation. Similarly, the wellsite system B (114-2) and wellsite system C (114-3) are associated with respective rigs, wellbores, other wellsite equipments, such as production equipment and logging equipment to perform production operation and logging operation, respectively. Generally, survey operations and wellbore operations are referred to as field operations of the field (100). In addition, data acquisition tools and wellsite equipments are referred to as field operation equipments. These field operations are performed as directed by a surface unit (112). For example, the field operation equipments may be controlled by a field operation control signal send from the surface unit (112).

In one or more embodiments, the surface unit (112) is operatively coupled to the data acquisition tools (102-1), (102-2), (102-3), (102-4), and/or the wellsite systems. 1.n particular, the surface unit (112) is configured to send commands to the data acquisition tools (102-1), (102-2), (102-3), (102-4), and/or the wellsite systems and to receive data therefrom. In one or more embodiments, surface unit. (112) may be located at the wellsite system A (114-1), wellsite system B (114-2), wellsite system C (114-3), and/or remote locations. The surface unit (112) may be provided with computer facilities e.g. an E&P computer system (118)) for receiving, storing, processing, and/or analyzing data from the data acquisition tools (102-1), (102-2), (102-3), (102-4), the wellsite system A (114-1), wellsite system B (114-2), wellsite system C (114-3), and/or other part of the field (104). The surface unit (112) may also be provided with or functionally for actuating mechanisms at the field (100). The surface unit (112) may then send command signals to the field (100) in response to data received, stored, processed, and/or analyzed, for example to control and/or optimize various field operations described above.

In one or more embodiments, the surface unit (112) is communicatively coupled to the E&P computer system (118). In one or more embodiments, the data received by the surface unit (112) may be sent to the E&P computer system (118) for further analysis. Generally, the E&P computer system (1 18) is configured to analyze, model, control, optimize, or perform management tasks of the aforementioned field operations based on the data provided from the surface unit (112). In one or more embodiments, the E&P computer system (118) is provided with functionality for manipulating and analyzing the data, such as performing seismic interpretation or borehole resistivity image log interpretation to identify geological surfaces in the subterranean formation (104) or performing simulation, planning, and optimization of production operations of the wellsite system A (114-1), wellsite system B (114-2), and/or wellsite system C (114-3). In one or more embodiments, the result generated by the E&P computer system (118) may be displayed for analyst user viewing using a two dimensional (2D) display, three dimensional (3D) display, or other suitable displays. Although the surface unit (1 I 2) is shown as separate from the E&P computer system (118) in FIG. 1.1, in other examples, the surface unit (112) and the E&P computer system (118) may also be combined.

Although FIG. 1.1 shows a field (100) on the land, the field (100) may be an offshore field. In such a scenario, the subterranean formation may be in the sea floor. Further, field data may be gathered from the field (100) that is an offshore field using a variety of offshore techniques for gathering field data.

FIG. 1.2 shows more details of the E&P computer system (208) in which one or more embodiments of cross section creation and modification may be implemented. In one or more embodiments, one or more of the modules and elements shown in FIG. 12 may be omitted, repeated, and/or substituted. Accordingly, embodiments of cross section creation and modification should not be considered limited to the specific arrangements of modules shown in FIG. 1.2.

As shown in FIG. 1.2, the E&P computer system (208) includes a field data analysis tool (230), a data repository (235) for storing intermediate data and resultant outputs of the field data analysis tool (230), and a field task engine (231) for performing various tasks of the field operation. In one or more embodiments, the data repository (235) may include one or more disk drive storage devices, one or more semiconductor storage devices, other suitable computer data storage devices, or combinations thereof. In one or more embodiments, content stored in the data repository (235) may be stored as a data file, a linked list, a data sequence, a database, a graphical representation, any other suitable data structure, or combinations thereof.

In one or more embodiments, the data generated by data acquisition tools depicted in FIG. 1.1 above are provided to the E&P computer system (208) and may be stored in the data repository (235) as the 3D data volume (227). In one or more embodiments, the 3D data volume (227) may include intermediate or final results of manipulating and/or analyzing e.g., using simulation and/or interpretation applications) the data generated by data acquisition tools depicted in FIG, 1.1 above. The data generated by these data acquisition tools and intermediate/final analysis results derived therefrom are referred to as field data. In other words, the 3D data volume (227) includes field data of the field (100) depicted in FIG. 1.1 above. Thus, the 3D data volume (227) represents properties of the field that may be calculated or gathered directly from the field.

In one or more embodiments, the 3D data volume (227) may be displayed to an analyst user performing analysis of data included in the 3D data volume (227). In other words, the analyst user may use the 3D data volume (227) to analyze the field data of the field (100). In one or more embodiments, the top of the displayed 3D data (221) volume corresponds to the earth surface the field (100) depicted in FIG. 1 above.

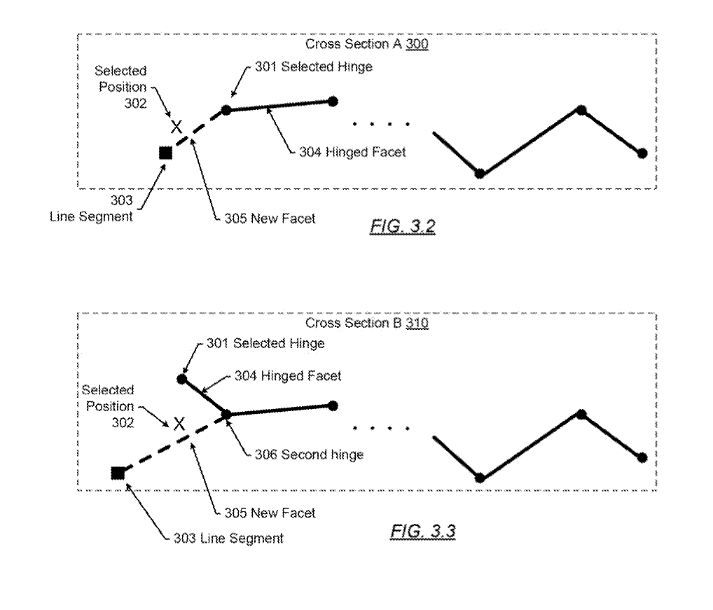

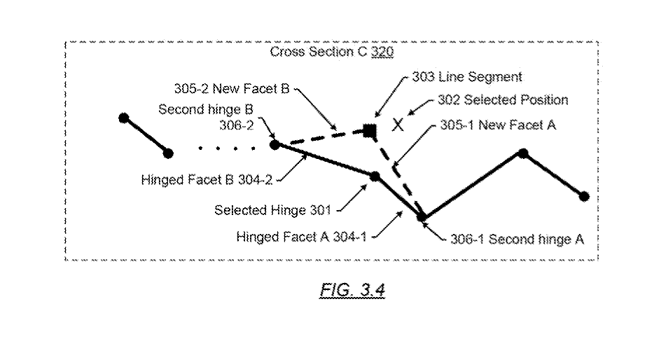

In one or more embodiments, the field data analysis tool (230) is configured to facilitate the analyst user to interactively modify or create a cross section (229) within the 3D data volume (227). The cross section (229) includes multiple facets (e.g., facets (229a)) connected to each other via hinges (e.g., hinges (229b)). In particular, a facet is a portion of a 21) plane bounded by a polygon within the 3D data volume (227) and a hinge is a line segment (i.e., an edge of the polygon) along which two facets join. In one or more embodiments, the hinges (229a) are parallel to each other along a pre-determined direction, such as the vertical direction in the 3D data volume or in a subterranean region represented by the 3D data volume in other embodiments, the hinges may not be parallel to each other. An example of the 3D data volume (227) and the cross section (229) is shown in FIG. 3.1 below.

As shown in FIG. 1.2, the field data analysis tool (230) includes the field data analyzer (222) that is configured to receive, from the analyst user, a selected position (not shown) within the 3D data volume (227), and detect a pre-determined feature e.g., one or more of the field data features (228)) of the field data to be within a pre-determined range of the selected position, in one or more embodiments, the field data features (228) includes natural features (e.g., geological features, petrophysical features, and/or petrochemical features) that may or may not be the result of human activity (e.g., tracking). In one or more embodiments, the field data features may be location of equipment (e.g., wellbores, wellheads, well logs, and other such equipment). If the pre-determined feature is a field data feature that is a natural feature, the pre-determined feature may be referred to as a pre-determined natural feature. If the pre-determined feature is a field data feature that is a location of equipment, the pre-determined feature may be referred to as a pre-determined equipment feature. The field data features (228) may be identified from the field data using simulation and/or interpretation applications.

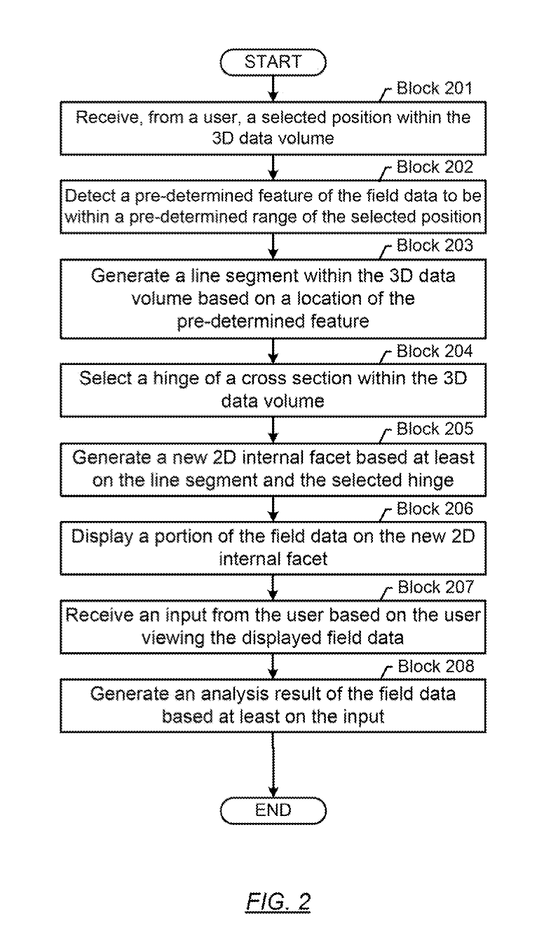

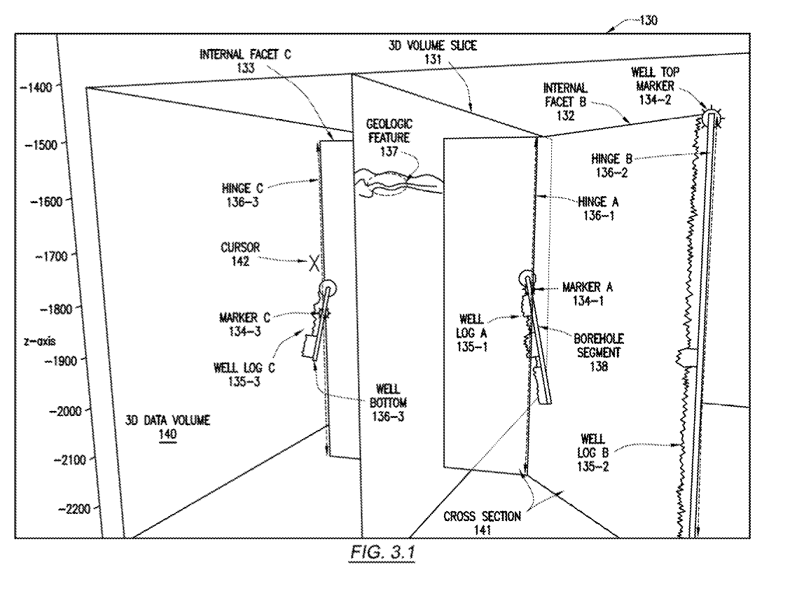

In one or more embodiments, the field data analysis tool (230) further includes a field data rendering module (225) that is configured to dynamically generate (i.e., render) a display image representing a selected portion of the 3D data volume (227) and the cross section (229) based on the detected pre-determined feature (e.g., one or more of the field data features (228)) of the field data. In one or more embodiments, the image is displayed to the analyst user to facilitate the modification and/or creation of the cross section (229). In particular, the portion of the field data corresponding to the location of the cross section (229) is selected for display on the cross section (229). For example, the portion may he highlighted so that the portion is more visible to the analyst user than the remainder of the field data away from the cross section (229). In other words, the portion of the field data may be rendered in the image using color and/or pattern that is more contrasting, bright, or otherwise more accentuated than the color and/or pattern of the remainder of the field data. In another example, the remainder of the field data away from the cross section (229) may not displayed or may he displayed so as to appear transparent. In one or more embodiments. The field data rendering module (225) uses the method described in reference to FIG. 2 below to generate the rendered image based on the detected pre-determined feature.

In one or more embodiments, in response to the analyst user viewing the portion of the field data displayed on the cross section (229), the field data analyzer (222) is further configured to receive an input from the analyst user, and generate an analysis result of the field data based at least on the input. For example, the input may include a command to a simulation/interpretation application (not shown), which may be used by the field data analyzer (222) to generate the analysis result. The simulation/interpretation application may be one or more of a geological, petrophysical, petrochemical simulator/interpreter, or any other simulator and/or interpreter. In one or more embodiments, the simulation/interpretation application is part of the field data analysis tool 0) and may be included in or separate from the field data analyzer 222).

In one or more embodiments, E&P computer system (208) includes the field task engine (231) that is configured to generate a field operation control signal based at least on the analyst user viewing data displayed on the cross section (229). As noted above, the field operation equipment depicted in FIG. 1 above may be controlled by the field operation control signal. For example, the field operation control signal may be used to control drilling equipment, an actuator, a fluid valve, or other electrical and/or mechanical devices disposed about the field (100) depicted in FIG. 1.1 above.

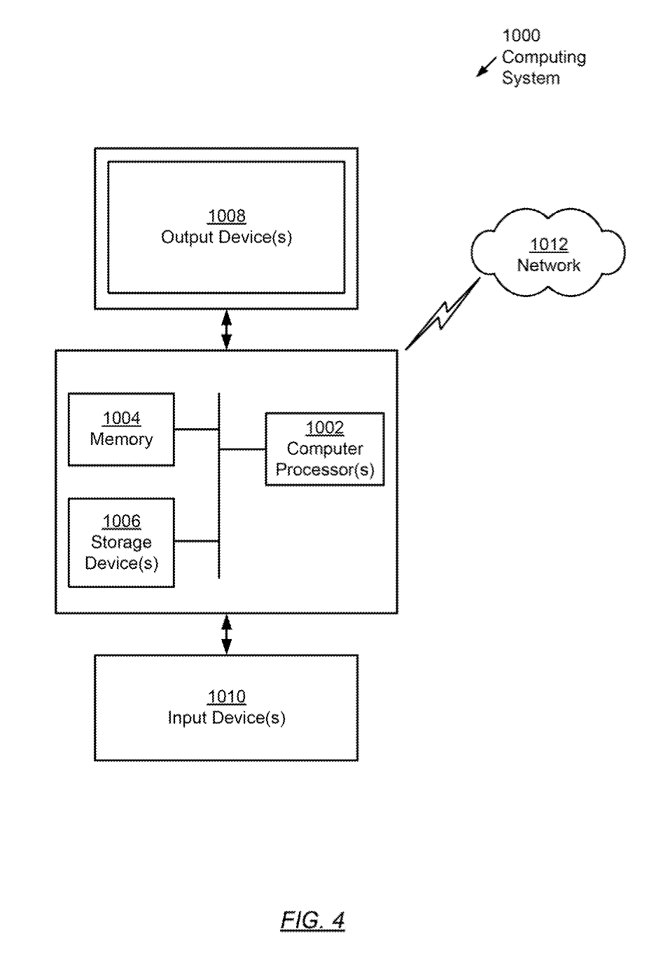

The E&P computer system (208) may include one or more system computers, such as shown in FIG. 4 below, which may be implemented as a server or any conventional computing system. However, those skilled in the art, having benefit of this disclosure, will appreciate that implementations of various technologies described herein may be practiced in other computer system configurations, including hypertext transfer protocol (HTTP) servers, hand-held devices, multiprocessor systems, microprocessor-based or programmable consumer electronics, network personal computers, minicomputers, mainframe computers, and the like.

While specific components are depicted and/or described for use in the units and/or modules of the E&P computer system (208) and the field data analysis tool (230), a variety of components with various functions may be used to provide the formatting, processing, utility and coordination functions for the E&P computer system (208) and the field data analysis tool (230). The components may have combined functionalities and may be implemented as software, hardware, firmware, or combinations thereof.

FIG. 2 depicts an example method in accordance with one or more embodiments. For example, the method depicted in FIG. 2 may be practiced using the E&P computer system (118) described in reference to FIGS. 1.1 and 1,2 above. In one or more embodiments, one or more of the elements shown in FIG. 2 may be omitted, repeated, and/or performed in a different order. Accordingly, embodiments of the method and system for sandbox visibility should not be considered limited to the specific arrangements of elements shown in FIG, 2.

In Block 201, a selected position within a 3D data volume is received from an analyst user. In one or more embodiments, the 3D data volume includes field data, which may include measured data and/or simulation data of a subterranean formation. For example, the measured data and/or simulation data may describe geological, petrophysical, and/or petrochemical properties of the subterranean formation. In one or more embodiments, the all data volume is displayed to the analyst user for selecting a position. In particular, the selected position may be selected by the analyst user via an analyst user interface element of the display such as a cursor or other types of pointer. In one or more embodiments, the selected position is selected during a drag-and-drop operation within the 3D data volume. For example, the selected position may be the destination of the drag-and-drop operation where a dragged object is dropped onto. In one or more embodiments, the selected position is selected during a point selection operation within the 3D data volume. For example, the selected position may be the point within the 3D data volume that is clicked by the analyst user using the cursor.

In Block 202, a pre-determined feature of the field data is detected to be within a pre-determined range of the selected position. For example, the pre-determined range may be 1 mm, 1.5 mm, or certain number of increments in the coordinates defining the 3D data volume. In other words, the selected position is found to be near the pre-determined feature within a pre-determined physical distance (e.g., 1 mm, 1.5 mm, etc.) or certain number of coordinate increments in the 3D data volume. For the pre-determined feature that spans more than a single position, the pre-determined range is defined based on a particular position of the feature, such as the head, tail, mid-point, or geometrical centroid of the pre-determined feature. If multiple pre-determined features are in proximity to the selected position, one or more criteria may be used to select a pre-determined feature. For example, the criterion may be the smallest distance, greatest amount of prior selection(s) of the feature or type of feature by the analyst user and/or other users, most related to the type of analysis being performed, and/or other criterion.

In Block 203, in response to detecting the pre-determined feature in proximity to the selected position, a line segment is generated within the 3D data volume based on a location of the pre-determined feature. For example, the line segment may start from or end at a particular position of the pre-determined feature. In another example, the mid-point of the line segment may fall onto a particular position of the pre-determined feature. In one of more embodiments, the line segment is generated upon the analyst user selecting the selected position and concurrently snapped onto the pre-determined feature upon detecting the aforementioned proximity. In one or more embodiments, the line segment is used as a new hinge to modify the cross section.

In one or more embodiments, the line segment has a pre-determined slope in the 3D data volume. For example, if the existing line segments are vertical, then the new line segment may also be vertical. By way of another example, if the existing line segments are angled or horizontal, then the new line segment is at the same angle or horizontal in accordance with one or more embodiments. In other embodiments, the line segment may be in a different direction than one or more other line segments of the cross section. For example, the line segment may be along a length of the pre-determined feature. By way of another example, two points and/or pre-determined features may be selected and used as the line segment.

As noted above, and depicted in an example described in reference to FIGS. 3.1, 3.2, 3.3, and 3.4 below, a cross section is a sequence of hinged 2D facets where field data included in the 3D data volume may be selectively displayed. In Block 204, a hinge of a cross section within the 3D data volume is selected for modifying the cross section. The selected hinge is an existing hinge on the cross section that is to bind a new 2D facet with the line segment. Selecting the hinge may be performed as follows.

If the analysis user selects the selected position by moving a previously existing hinge on the cross section to the selected position, then the selected hinge may be an adjacent hinge to the previously existing hinge. In other words, previously existing hinge bounded two facets, where each facet is also bounded by an adjacent hinge. One of the adjacent hinges is selected as the selected hinge in Block 204. Block 204 and 20 may be repeated for the other adjacent hinge.

If the analysis user selects the selected position by moving a point on a previously existing facet on the cross section to the selected position, then the selected hinge may be one of the hinges that bound the previously existing facets. In other words, the previously existing facet is bounded by at least two hinges. One of the binding hinges is selected as the selected hinge in Block 204 Block 204 and 205 may be repeated for the other binding hinge.

If the analysis user selects a new position that is not going of an existing, position on the cross section, then the line segment may be deemed as an end hinge for the cross section. In such a scenario, the selected hinge may he the prior closest end hinge of the cross section that is referred to as the initial end hinge for this discussion. In other words, the initial end hinge is no longer at the end of the cross section and the new hinge becomes the new end hinge. In one or more embodiments, the initial end hinge is dragged-and-dropped near the pre-determined feature of the field data where the new hinge is automatically generated and snapped onto the pre-determined feature. In such embodiments, the new 2D facet of Block 205 is bounded on two sides by this initial end hinge and a new hinge defined by the line segment of Block 203. Accordingly, the new 2D facet is appended to the initial end hinge to expand the cross section from the initial end hinge to the new hinge.

In Block 205, a new 20 facet is generated within the 30 data volume based at least on the line segment and the selected hinge. In other words, grid points of the 3D data volume that are directly in between the line segment and the selected hinge are identified. The properties of the 3D data volume to display are identified. For example, the properties may he identified based on being previously displayed, being selected by the analysis user, or corresponding to the type of analysis being performed. A graphical representation of the values of the properties of the identified grid points are displayed at the identified grid points.

In one or more embodiments, the selected position of Block 201 is received from the analyst user based on a user instruction to move the selected hinge of Block 204 to the selected position. In particular, the selected hinge is on one side of a hinged. 20 facet of the cross section where the other hinge of this hinged 2D facet is referred to as a second hinge for this discussion. For example, the user instruction may be in the form of a drag-and-drop operation where the selected hinge is dragged to and dropped at the selection position while the second hinge stays in place. As described above, a line segment is generated at the selected position and automatically snapped onto a near-by pre-determined feature of the field data to become a new hinge. In such embodiments, the new hinge replaces the selected hinge in the cross section. Accordingly, the new 2D facet of Block 205 is bounded on two sides by the new hinge line segment of Block 203) and the aforementioned second hinge. In other words, the aforementioned hinged 2D facet attached to the selected hinge is replaced by this new 20 facet. FIG. 3.3 shows an example where this new hinge replaces the selected hinge as an end hinge of the cross section. FIG. 3.4 shows an example where this new hinge replaces the selected hinge as an internal hinge (i.e., not at the end) of the cross section.

Returning to the discussion of FIG. 2, in Block 206, an additional portion of the field data corresponding to the new 2D facet of Block 205 is displayed on this new 211) facet. In one or more embodiments where the cross section is expanded by the modification, the additional portion of the field data adds to the initial portion of field data already displayed on the cross section. In one or more embodiments where one or more facets of the cross section is/are replaced by the modification, the additional portion of the field data replaces part of the initial portion of field data already displayed on the cross section.

In Block 207, in response to the analyst user viewing the additional portion of the field data displayed on the new 2D facet, an input is received from the analyst user. For example, the input may be used by a simulator or interpretation application to generate an analysis result of the field data set (Block 208).

FIGS. 3.1, 3.2, 3.3, and 3.4 show an example in one or more embodiments. The following example is for example purposes and not intended to limit the scope of the claims.

FIG. 3,1 shows a screenshot (130) of a 3D data volume (140), which is an example of the 3D data volume (227) shown in FIG. 1.2 above. As shown in FIG. 3.1, the 3D data volume (140) includes field data, such as illustrated as the data pattern depicted on the 3D volume slice (131). A particular geological feature (137) is identified from the data pattern, which may represent a fault line., a peak, or a discontinuity identified from seismic data, or other measured/simulated geological, petrophysical, or petrochemical data. For example, the geological feature (137) may represent, based on measurement of simulation, a discontinuity of paleontology age likelihood, a horizon dislocation, horizon fault lines, fluvial facies, fracture lines, deformation, stress tensor discontinuity, porosity discontinuity, permeability discontinuity, pressure discontinuity, and other geological features.

Further as shown in FIG. 3.1, the field data includes a well log A (135-1) displayed along a deviated borehole segment (138) identified by the marker A (134-1), a well log B (135-2) displayed along a vertical borehole identified by the well top marker (134-2), and a well log C (135-3) displayed along a deviated borehole identified by the marker C (134-3) and ending at the well bottom (136-3). Three vertical line segments defined, by the marker A (134-1), the well log B (135-2), and the marker C (134-3) have been selected as the hinge A (136-1), hinge B (136-2), and hinge C (136-3) to define the facet B (132) and the facet C (133). The facet B (132) and the facet C (133) are examples of 21) hinged facets that form a cross section (141) of the 3D data volume (140). As described above, the cross section (141) may be modified by selecting a position near the geological feature (137) as a location of a new hinge or where one of the existing hinges is to be moved to. For example, the position may be selected using the cursor (142) to drag the hinge C (136-3) toward the geological feature (137). Once the hinge C (136-3) is within a pre-determined range of the geological feature (137), the hinge C (136-3) is snapped to a vertical line defined by the geological feature (137). The vertical line becomes the new location of the hinge C (136-3). Accordingly, the facet C (133) swipes across the 3D data volume (140) along with the dragging motion of the hinge C (136-3). While the data pattern representing the field data of the 3D data volume (140) is shown on the 3D volume slice (131) for illustration purpose, the portion of the field data corresponding to locations across the surface of the cross section (141) are displayed prominently on the cross section (141) to be emphasized over any remainder portion of the field data. For example, the remainder portion of the field data may be suppressed or not displayed to highlight the portion of the field data displayed on the cross section (141). In FIG. 3.1, the portion of the field data displayed on the cross section (141) is not shown for clarity of other details of the screenshot (130). Although two facets are shown in FIG. 3.1, the cross section may include more than two facets in other examples, such as shown in top views in FIGS. 3.2, 3.3, and 3.4 below.

FIG. 3.2 shows an example cross section A (300) of an example 3D data volume in a top view. For example, this example 3D data volume may be substantially the same as the 3D data volume (140) shown in FIG. 3.1 above where the cross section (141) has been expanded with additional hinges and facets. In particular, the expanded version of the cross section (141) has hinges and facets represented by circles and solid line segments, respectively in FIG.

As shown in FIG. 3.2, the selected hinge (301) is an end hinge of the cross section having the hinged facet (304) in addition to other hinge/facets represented by circles and solid line segments. The selected position (302) is used to automatically generate the line segment (303) that is snapped to an adjacent feature (not shown) of the field data. In this example, the line segment (303) is used as a new hinge creating a new facet (305) to expand the cross section. Specifically, the new facet (305) is bounded on two sides by the line segment and the end hinge. Further, the new facet (305) is appended at the end of the initial cross section. Examples of the feature where the new hinge is snapped to are described in reference to FIG. 3.1 above and are not explicitly shown in FIG. 3.2 so as not to obscure other details.

FIGS. 3.3 and 3,4 show an example cross section B (310) and example cross section C (320), respectively, of an example 3D data volume in the top view. For example, this example 3D data volume may be substantially the same as the 3D data volume (140) shown in FIG. 3.1 above where the cross section (141) has been expanded with additional hinges and facets. In particular, the expanded version of the cross section (1141) has hinges and facets represented by circles and solid line segments, respectively in FIGS. 3.3 and 3.4.

As shown in FIGS. 3.3 and 3.4, the selected position (302) is received from the analyst user based on a user instruction to move the selected hinge (301) to the selected position (302). The selected position (302) is used to automatically generate the line segment (303) that is snapped to an adjacent feature (not shown) of the field data. Examples of the feature where the line segment (303) is snapped to are described in reference to FIG. 3.1 above and are not explicitly shown in FIGS. 3.3 and 3.4 so as not to obscure other details.

In the example shown in FIG. 3.3, the line segment (303) is used as a new hinge creating a new facet (305) to modify the cross section. Specifically, the new facet (305) is bounded on two sides by the line segment (303) and the second hinge (306) of the hinged facet (304). Further, after the modification, the new facet (305) in the modified cross section replaces the hinged facet (304) in the initial cross section. In one or more embodiments, the selected, hinge (301) is moved toward the selected position (302) by way of a drag-and-drop operation performed by the analyst user. During the drag-and-drop operation, the hinged facet (304) (referred to as a swiping facet in this context) swipes across the 3D data volume where corresponding portions of field data are dynamically displayed on the swiping facet. Viewing by the analyst user, the dynamically changing data displayed on the swiping facet forms a sequence of animation until the swiping facet rests hinged at the snapped-to location of the line segment (303).

In the example shown in FIG. 3.4, the selected hinge (301) connects the hinged facet A (304-1) and the hinged facet B (304-2). Further, the line segment (303) is used as a new hinge creating a new facet A (305-1) and a new facet B (305-2) to modify the cross section. Specifically, the new facet A (305-1) is bounded on two sides by the line segment (303) and the second hinge A (306-1) of the hinged facet A (304-1), and the new facet B (305-2) is bounded on two sides by the line segment (303) and the second hinge B (306-2) of the hinged facet B (304-2). Further, after the modification, the new facet A (305-1) and new facet B (305-2) in the modified cross section replaces the hinged facet A (304-1) and hinged facet B (304-2) in the initial cross section. In one or more embodiments, the selected hinge (301) is moved toward the selected position (302) by way of a drag-and-drop operation performed by the analyst user. During the drag-and-drop operation, the hinged facet A (304-1) and hinged facet B (304-2) (referred to as swiping facets in this context) swipe across the 3D data volume where corresponding portions of field data are dynamically displayed on the swiping facets. Viewing by the analyst user, the dynamically changing data displayed on the swiping facets forms a sequence of animation until the swiping facets rest hinged at the snapped-to location of the line segment (303).

Embodiments may be implemented on virtually any type of computing system regardless of the platform being used. For example, the computing system may he one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments. For example, as shown in FIG. 4, the computing system (1000) may include one or more computer processor(s) (1002), associated memory (1004) (e.g., random access memory (RAM), cache memory, flash memory, etc.), one or more storage device(s) (1006) (e.g., a hard disk, an optical drive such as a compact disk (CD) drive or digital versatile disk (DVD) drive, a flash memory stick, etc.), and numerous other elements and functionalities. The computer processor(s) (1002) may be an integrated circuit for processing instructions. For example, the computer processor(s) may be one or more cores, or micro-cores of a processor. The computing system (1000) may also include one or more input device(s) (1010), such as a touchscreen, keyboard, mouse, microphone, touchpad, electronic pen, or any other type of input device. Further, the computing system (1000) may include one or more output device(s) (1008), such as a screen e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (1000) may be connected to a network (1012) (e.g., a local area network (LAN), a wide area network (WAN) such as the Internet, mobile network, or any other type of network) via a network interface connection (not shown). The input and output device(s) may be locally or remotely (e.g., via the network (1012)) connected to the computer processor(s) (1002), memory (1004), and storage device(s) (1006). Many different types of computing systems exist, and the aforementioned input and output device(s) may take other forms.

Software instructions in the form of computer readable program code to perform embodiments may be stored, in whole or in part, temporarily or permanently, on a non-transitory computer readable medium such as a CD. DVD, storage device, a diskette, a tape, flash memory, physical memory, or any other computer readable storage medium. Specifically, the software instructions may correspond to computer readable program code that when executed by a processor(s), is configured to perform embodiments.

Further, one or more elements of the aforementioned computing system (1000) may be located at a remote location awl connected to the other elements over a network (1012). Further, embodiments may be implemented on a distributed system having a plurality of nodes, where each portion may be located on a different node within the distributed system. In one embodiment, the node corresponds to a distinct computing device. The node may correspond to a computer processor with associated physical memory. The node may correspond to a computer processor or micro-core of a computer processor with shared memory and/or resources.

While one or more embodiments have been described with respect to a limited number of embodiments, those skilled in the art, having benefit of this disclosure, will appreciate that other embodiments can be devised which do not depart from the scope as disclosed herein. Accordingly, the scope should be limited only by the attached claims.

What is claimed is:

1. A method for analyzing a three-dimensional (3D) data volume, comprising:
receiving, from an analyst user, a selected position within the 3D data volume, wherein the 3D data Volume campuses field data
detecting, by a processor of a computer system, a pre-determined natural feature of the field data to be within a pre-determined range of the selected position;
generating, by the processor and in response to the detecting, a line segment within the 3D data volume based on a location of the pre-determined natural feature;
selecting a first hinge of a first hinged two-dimensional (2D) facet in a sequence of hinged 2D facets within the 3D data volume, wherein the sequence of hinged 2D facets correspond to a portion of the field data that is displayed on the sequence of hinged 2D facets:
generating, by the processor and based at least on the line segment and the first hinge, a first new 2D facet within the 3D data volume, and
displaying, to the analyst user, an additional portion of the field data corresponding to the first new 2D facet, wherein the additional portion of the field data is displayed on the first new 2D facet.

2. The method of claim 1, further comprising:
further receiving, in response to the analyst user viewing the additional portion of the field data on the first new 2D facet, an input from the analyst user; and
generating an analysis result of the field data based at least on the input.

3. The method of claim 1,
wherein the selected position is received from the analyst user based on a user instruction to move the first hinge to the selected position,
wherein the first new 2D facet is bounded by the line segment and a second hinge of the first hinged 2D facet, and
wherein the method further comprises:
replacing the first hinge by the line segment; and
replacing the first hinged 2D facet by the first new 2D facet that is hinged using at least the second hinge.

4. The method of claim 3,
wherein the first binge is an end hinge of the sequence of hinged 2D facets.

5. The method of claim 3,
wherein the first hinge connects the first hinged 2D facet and a second hinged 2D facet of the sequence of hinged 2D facets, and
wherein the method further comprises:
replacing the second hinged 2D facet by a second new 2D facet that is bounded by the line segment and a third hinge of the second hinged 2D facet.

6. The method of claim 1, further comprising:
appending the first new 2D facet to the sequence of hinged 2D facets,
wherein the first hinge is an end hinge of the sequence of hinged 2D facets, and
wherein the first new 2D facet is hounded by the line segment and the end hinge.

7. The method of claim 1,
wherein the field data comprises at least one selected from a group consisting of measured data and simulation data of a subterranean formation,

8. A system for analyzing a three-dimensional (3D) data volume, comprising:
a data repository configured to store the 3D data volume;
a display device configured to selectively display the 3D data volume;
a computer processor; and
memory storing instructions executed by the computer processor, wherein the instructions comprise:
a field data analyzer configured to:
receive, from an analyst user, a selected position within the 3D data volume, wherein the 3D data volume comprises field data, and
detect a pre-determined natural feature of the field data to be within a pre-determined range of the selected position, and
a field data rendering module configured to:
generate, in response to the detecting, a line segment within the 3D data volume based on a location of the pre-determined natural feature,
select a first hinge of a first hinged two-dimensional (2D) facet in a sequence of hinged 2D facets within the 3D data volume, wherein the sequence of hinged 2D facets correspond to a portion of the field data that is displayed on the sequence of hinged 2D facets,
generate, based at least on the line segment and the first hinge, a first new 2D facet within the 3D data volume, and
select an additional portion of the field data corresponding to the first new 2D facet, wherein the additional portion of the field data is displayed on the first new 2D facet.

9. The system of claim 8, the field data analyzer further configured to:
further receive, in response to the analyst user viewing the additional portion of the field data on the first new 2D facet, an input from the analyst user; and
generate an analysis result of the field data based at least on the input.

10. The system of claim 8,
wherein the selected position is received from the analyst user based on a analyst user instruction to move the first hinge to the selected position,
wherein the first new 2D facet is bounded by the line segment and a second hinge of the first hinged 2D facet, and
wherein the instructions when executed by the computer processor further comprise functionality for:
replacing the first hinge by the line segment, and
replacing the first hinged 2D facet by the first new 2D facet that is hinged using at least the second hinge.

11. The system of claim 10,
wherein the first hinge is an end hinge of the sequence of hinged 2D facets.

12. The system of claim 10,
wherein the first hinge connects the first hinged 2D facet and a second hinged 2D facet of the sequence of hinged 2D facets, and
wherein the instructions when executed by the computer processor further comprise functionality for:
replacing the second hinged 2D facet by a second new 2D facet that is bounded by the line segment and a third hinge of the second hinged 2D facet.

13. The system of claim 8, the field data rendering module further configured to:
append the first new 2D facet to the sequence of hinged 2D facets,
wherein the first hinge is an end hinge of the sequence of hinged 2D facets, and
wherein the first new 2D facet is bounded by the line segment and the end hinge.

14. The system of claim 1,
wherein the field data comprises at least one selected from a group consisting of measured data and simulation data of a. subterranean formation.

15. A non-transitory computer readable medium comprising computer readable program code for:
receiving, from an analyst user, a selected position within a three-dimensional (3D) data volume, wherein the 3D data volume comprises field data
detecting, by a processor of a computer system, a pre-determined natural feature of the field data to be within a pre-determined range of the selected position
generating, by the processor and in response to the detecting, a line segment within the 3D data volume based on a location of the pre-determined natural feature;
selecting a first hinge of a first hinged two-dimensional (2D) facet in a sequence of hinged 2D facets within the 3D data volume, wherein the sequence of hinged 2D facets correspond to a portion of the field data that is displayed on the sequence of hinged 2D facets;
generating, by the processor and based at least on the line segment and the first hinge, a first new 2D facet within the 3D data volume; and
displaying, to the analyst user, an additional portion of the field data corresponding to the first new 2D facet, wherein the additional portion of the field data is displayed on the first new 2D facet.

16. The non-transitory computer readable medium of claim 15, further comprising computer readable program code for:
further receiving, in response to the analyst user viewing the additional portion of the field data on the first new 2D facet, an input from the analyst user: and
generating an analysis result of the field data based at least on the input.

17. The non-transitory computer readable medium of claim 15,
wherein the selected position is received from the analyst user based on a user instruction to move the first hinge to the selected position,
wherein the first new 2D facet is bounded by the line segment and a second hinge of the first hinged 2D facet, and
wherein the non-transitory computer readable medium further comprises computer readable program code for:
replacing the first hinge by the line segment; and
replacing the first hinged 2D facet by the first new 2D facet that is hinged using at least the second hinge.

18. The non-transitory computer readable medium of claim 17,
wherein the first hinge is an end hinge of the sequence of hinged 2D facets.

19. The non-transitory computer readable medium of claim 17,
wherein the first hinge connects the first hinged 2D facet and a second hinged 2D facet of the sequence of hinged 2D facets, and
wherein the non-transitory computer readable medium further comprises computer readable program code for:
replacing the second hinged 2D facet by a second new 2D facet that is bounded by the line segment and a third hinge of the second hinged 2D facet.

20. The non-transitory computer readable medium of claim 15, further comprising computer readable program code for:
appending the first new 2D facet to the sequence of hinged 2D facets,
wherein the first hinge is an end hinge of the sequence of hinged 2D facets, and
wherein the first new 2D facet is bounded by the line segment and the end hinge.
